(19) United States
(12) Patent Application Publication
(10) Pub. No.: US 2019/0361177 A1
(43) Pub. Date: Nov. 28, 2019

(54) OPTICAL CONNECTOR AND OPTICAL FIBER WITH CONNECTOR

(71) Applicant: SEI Optifrontier Co., Ltd., Yokohama-shi, Kanagawa (JP)

(72) Inventors: Yohei AOSHIMA, Yokohama-shi, Kanagawa (JP); Yuji SUZUKI, Yokohama-shi, Kanagawa (JP); Tomoyuki YOKOKAWA, Yokohama-shi, Kanagawa (JP)

(73) Assignee: SEI Optifrontier Co., Ltd., Yokohama-shi, Kanagawa (JP)

(21) Appl. No.: 16/480,753

(22) PCT Filed: Nov. 2, 2017
(86) PCT No.: PCT/JP2017/039795

§ 371 Date: Jul. 25, 2019

(30) Foreign Application Priority Data
Jan. 31, 2017 (JP) 2017-015982

(51) Int. Cl. G02B 6/38; G02B 6/44

(52) U.S. Cl. CPC G02B 6/3825; G02B 6/4471

(57) ABSTRACT

An optical connector includes: a housing which includes an optical connector portion provided in a front portion in a first direction and inserted into a connector inlet of an adapter or a receptacle and a latch portion extending from a rear portion to the front portion in the first direction and engaging with the adapter or the receptacle; and a tab which extends from an outer surface of the housing to the rear side of the housing in the first direction and is attached to the outer surface so as to be slidable in the first direction. The latch portion includes a portion which extends in a second direction intersecting the first direction. The tab includes an inclined surface which is inclined with respect to the first direction and contacts the portion and slides backward to press the portion. The tab and the housing have a slidable engagement mechanism.

### TECHNICAL FIELD

The present disclosure relates to an optical connector and an optical fiber with a connector. This application claims priority based on Japanese Patent Application No. 2017-015982 filed on Jan. 31, 2017 and all the contents described in the aforementioned Japanese application are incorporated herein.

### BACKGROUND ART

Patent Literature 1 describes a technique for an optical connector plug. The optical connector plug described in the literature includes a slider and a plug body with a releasing lever. The releasing lever is formed on one surface of the plug body in a longitudinal direction from a front side to a rear side. The releasing lever engages with an adapter or a receptacle in an attachable or detachable manner. The slider is attached to the plug body so as to be movable in an axial direction of the plug body within a regulated range of the axial direction. A front portion of the slider is provided with a tapered surface pressably engaging with a releasing piece of the releasing lever.

Patent Literature 2 describes a technique for an LC-type optical connector plug. The optical connector plug described in the literature further includes an operation tab in addition to the plug body and the slider which are similar to those in Patent Literature 1. The operation tab is attached to a rear portion of the slider in an attachable or detachable manner.

### CITATION LIST

### Patent Literature

Patent Literature 1: Japanese Unexamined Patent Publication No. 2009-229545

Patent Literature 2: Japanese Unexamined Patent Publication No. 2015-200771

### SUMMARY OF INVENTION

An optical connector according to an embodiment is an optical connector which is connected to an adapter or a receptacle in a first direction, including: a housing which includes an optical connector portion provided in a front portion in the first direction and inserted into a connector inlet of the adapter or the receptacle and a latch portion extending from a rear portion to the front portion in the first direction and engaging with the adapter or the receptacle; and a tab which extends from an outer surface of the housing to the rear side of the housing in the first direction and is attached to the outer surface so as to be slidable in the first direction. The latch portion includes a portion which extends in a second direction intersecting the first direction. The tab includes an inclined surface which is inclined with respect to the first direction and contacts the portion and slides backward to press the portion. The tab and the housing have a slidable engagement mechanism.

### BRIEF DESCRIPTION OF DRAWINGS

FIG. 1 is a perspective view illustrating an appearance of an optical connector according to an embodiment.

FIG. 2 is a top view of the optical connector illustrated in FIG. 1.

FIG. 3 is a side view of the optical connector illustrated in FIG. 1.

FIG. 4 is a perspective view illustrating an appearance of a first housing and a boot.

FIG. 5 is a perspective view illustrating a second housing viewed from the obliquely front side.

FIG. 6 is a perspective view illustrating the second housing viewed from the obliquely rear side.

FIG. 7 is a side view of the second housing.

FIG. 8 is a top view of the second housing.

FIG. 9 is a perspective view illustrating a tab viewed from the obliquely upper side.

FIG. 10 is a perspective view illustrating the tab viewed from the obliquely lower side.

FIG. 11 is a perspective view illustrating an assembly state of the second housing and the tab viewed from the obliquely upper side.

FIG. 12 is a perspective view illustrating the assembly state of the second housing and the tab viewed from the obliquely lower side.

FIG. 13 is a cross-sectional view taken along a line XIII-XIII illustrated in FIG. 11.

FIG. 14 is a front view illustrating the assembly state of the second housing and the tab.

FIG. 15 is a perspective view illustrating an appearance of an adapter.

FIG. 16 is a diagram for describing an operation at the time of releasing an engagement state of a latch portion.

FIG. 17 is a diagram for describing the operation at the time of releasing the engagement state of the latch portion.

### DESCRIPTION OF EMBODIMENTS

### Problems to be Solved by Disclosure

For example, at the time of connecting an LC-type optical connector to an adapter or a receptacle, a latch portion engages with the adapter or the receptacle. By this engagement, the optical connector prevents an unintentional separation of the adapter or the receptacle. Thus, at the time of removing the optical connector from the adapter or the receptacle, there is a need to release an engagement state between the latch portion and the adapter or the engagement state between the latch portion and the receptacle. For example, a conventional optical connector releases such an engagement state by pressing a lever using a finger so as to cover the latch portion. However, in recent communication base stations and the like, a density of optical wiring increases as the communication capacity rapidly increase. Thus, an installation interval of optical connectors also becomes smaller. For that reason, it is difficult to directly access the optical connector from a gap between the optical wirings. Thus, there is also a demand for a mechanism for releasing the engagement state of the latch portion (for example, see Patent Literatures 1 and 2). Meanwhile, it is desirable to simplify a structure of the optical connector in order not to impair the reliability of the optical connector. Additionally, the adapter is generally used to connect connectors. The receptacle is generally used to connect a connector to a device. Both of the adapter and the receptacle include a connector inlet.

The disclosure has been made in view of such problems and an object thereof is to provide an optical connector and an optical fiber with a connector capable of easily releasing the engagement state of the latch portion even when the density of optical wiring increases and simplifying a structure for releasing the engagement state of the latch portion.

### Effect of Disclosure

According to the optical connector and the optical fiber with the connector of the disclosure, it is possible to easily release an engagement state of a latch portion even when the density of optical wiring increases and to simplify a structure for releasing the engagement state of the latch portion.

### Description of Embodiments

Above all, the contents of the embodiment of the disclosure will be described. An optical connector according to the embodiment is an optical connector which is connected to an adapter or a receptacle along a first direction, including: a housing which includes an optical connector portion provided in a front portion in the first direction and inserted into a connector inlet of the adapter or the receptacle and a latch portion extending from a rear portion to the front portion in the first direction and engaging with the adapter or the receptacle; and a tab which extends from an outer surface of the housing to the rear side of the housing in the first direction and is attached to the outer surface so as to be slidable in the first direction. The latch portion includes a portion which extends in a second direction intersecting the first direction. The tab includes an inclined surface which is inclined with respect to the first direction and contacts the portion and slides backward to press the portion. The tab and the housing have a slidable engagement mechanism.

In the optical connector, the tab which is attached so as to be slidable in the first direction extends from an outer surface of the housing toward the rear side of the housing. At the time of releasing the engagement state of the latch portion, a rear end portion of the tab is pinched with fingers and is pulled backward. Accordingly, the inclined surface of the tab presses the latch portion. Thus, the optical connector can easily release the engagement state of the latch portion even when the density of optical wiring increases. Further, in the optical connector, the tab and the housing have a slidable engagement mechanism. Accordingly, the optical connector does not require, for example, a large-scale configuration as in the slider described in Patent Literatures 1 and 2. Then, the optical connector can simplify a structure for releasing the engagement state of the latch portion.

In the optical connector, the mechanism may include a slit which is formed in the housing and extends in the first direction and a protrusion which is formed in the tab, engages with the slit, and has a T-shaped cross-section. For example, according to such a configuration, a slidable engagement mechanism of the tab and the housing can be realized by a simple configuration.

In the optical connector, the housing may include a narrow portion which sandwiches the tab from a direction intersecting the first direction, the tab may include a pair of protrusion which protrudes outward in the direction, a front end of the protrusion may come into contact with a rear end of the narrow portion, and a surface of a rear portion of the protrusion may be inclined with respect to the first direction. For example, according to such a configuration, it is possible to easily and reliably attach the tab to the housing by inserting the tab from the front side of the narrow portion. Further, it is possible to transmit a force in which an operator presses the tab forward to the housing through the protrusion and the narrow portion at the time of connecting the optical connector to the adapter or the receptacle. In this case, the tab may further include a slit which is formed between the pair of protrusions and extends in the first direction. Accordingly, the pair of protrusions can be elastically deformed toward the inside of the tab. Thus, the tab can be more easily attached to the housing.

An optical fiber with a connector according to an embodiment includes any one of the above-described optical connectors and an optical fiber cable which includes an optical fiber extending from the optical connector portion and extends backward from a rear end of the housing in the first direction. The optical fiber with the connector includes any one of the above-described optical connectors. Accordingly, even when the density of optical wiring increases, it is possible to easily release the engagement state of the latch portion and to simplify a structure for releasing the engagement state of the latch portion.

### Detail of Embodiment

Detailed examples of the optical connector and the optical fiber with the connector of the embodiment of the disclosure will be described below with reference to the drawings. Additionally, the disclosure is not limited to the examples, but is shown by the scope of the claims. Then, it is intended to include all modifications within the scope of the claims and meaning equivalent to the scope of the claims. In the following description, the same reference numerals will be given to the same components in the description of the drawings and a redundant description will be omitted. Further, in the following drawings, an XYZ coordinate system is illustrated if necessary. A Z direction is a first direction of the embodiment. The Z direction indicates an insertion direction (a front and rear direction) of an optical connector with respect to an adapter or a receptacle. An X direction is a second direction of the embodiment. The X direction indicates a left and right direction of the optical connector. A Y direction is a third direction of the embodiment. The Y direction indicates an up and down direction of the optical connector. The X direction, the Y direction, and the Z direction intersect one another. In an example, the X direction, the Y direction, and the Z direction are orthogonal to one another.

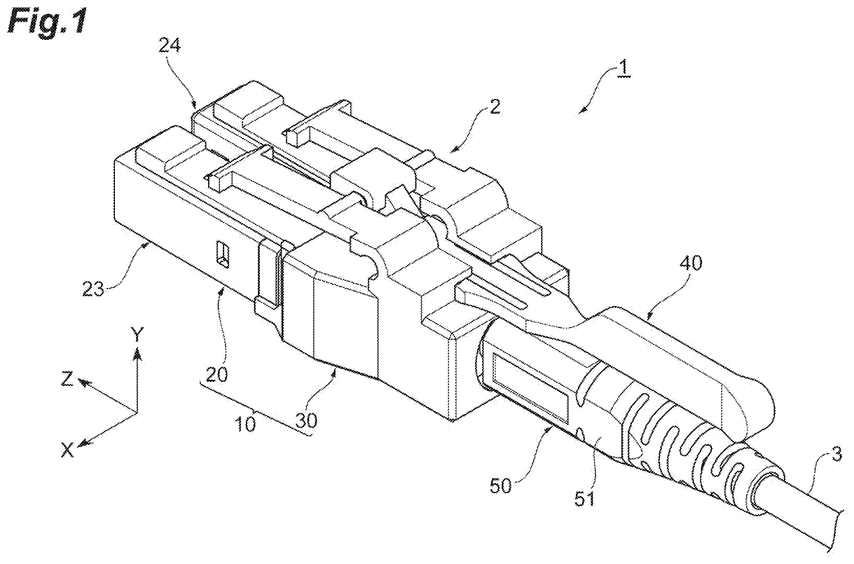

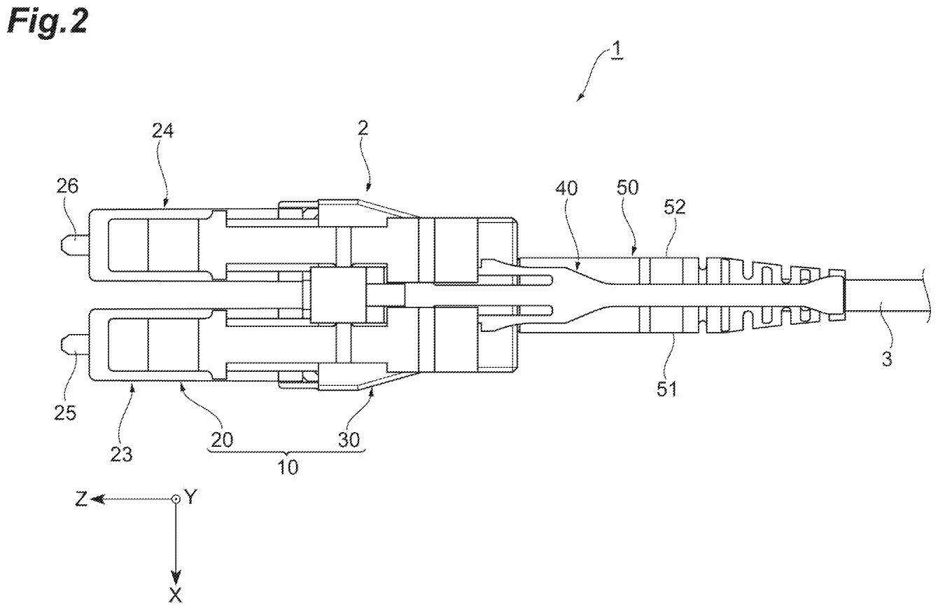

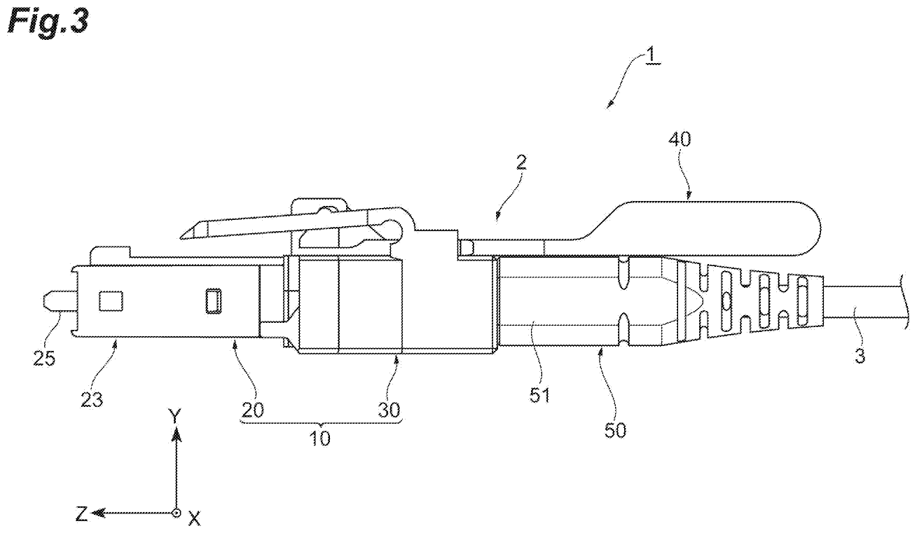

FIG. 1 is a perspective view illustrating a configuration of an optical fiber 1 with the connector according to an embodiment. FIG. 2 is a top view of the optical fiber 1 with the connector illustrated in FIG. 1. FIG. 3 is a side view of the optical fiber 1 with the connector illustrated in FIG. 1. As illustrated in FIGS. 1, 2, and 3, the optical fiber 1 with the connector includes an optical connector 2 and an optical fiber cable 3. The optical connector 2 includes a housing 10, a tab 40, and a boot 50. The housing 10 includes a first housing 20 and a second housing 30.

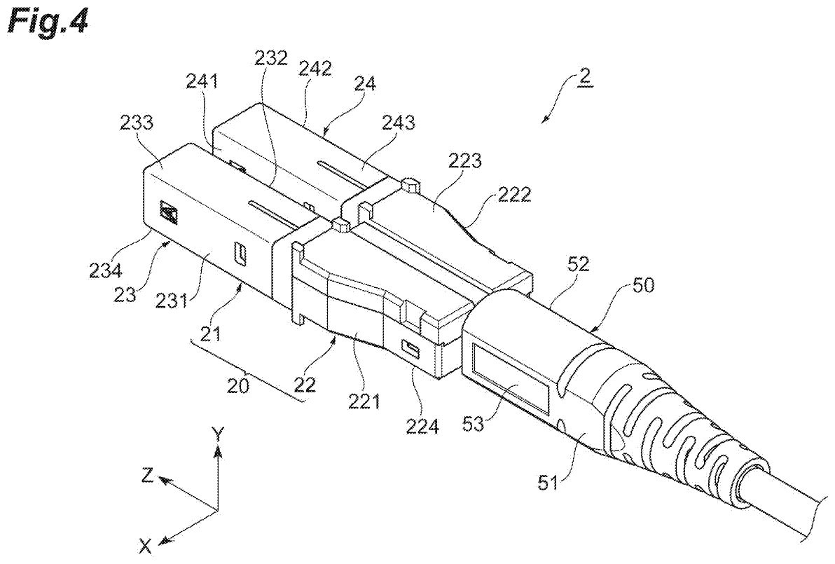

FIG. 4 is a perspective view illustrating an appearance of the first housing 20 and the boot 50. The first housing 20 is formed of, for example, a resin material called polyetherimide (PEI). The first housing 20 includes a front portion 21 (a front housing) and a rear portion 22 (an inner housing) which are arranged in the Z direction. The first housing 20 extends forward and backward along the Z direction. Additionally, the front portion 21 and the rear portion 22 may be integrally molded with each other. Further, the front portion 21 and the rear portion 22 may be molded as separate components and may be integrally assembled.

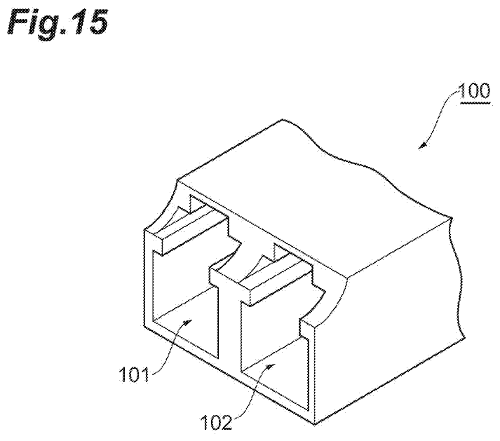

The front portion 21 includes a first optical connector portion 23 and a second optical connector portion 24. The first optical connector portion 23 and the second optical connector portion 24 are arranged in the X direction. The first optical connector portion 23 and the second optical connector portion 24 respectively extend forward and backward along the Z direction. The first optical connector portion 23 is a single-core optical connector. The first optical connector portion 23 is inserted into a first connector inlet 101 of an adapter 100 illustrated in FIG. 15. The first optical connector portion 23 accommodates a single-core optical fiber and a ferrule 25 (see FIGS. 2 and 3) which holds a front end portion of the optical fiber. The second optical connector portion 24 is a single-core optical connector. The second optical connector portion 24 is inserted into a second connector inlet 102 of the adapter 100 illustrated in FIG. 15. The second optical connector portion 24 accommodates another single-core optical fiber and another ferrule 26 (see FIG. 2) holding a front end portion of the optical fiber. The first optical connector portion 23 transmits, for example, upstream signal light. The second optical connector portion 24 transmits, for example, downstream signal light. The optical connector portions 23 and 24 respectively support the base end portions of the ferrules 25 and 26 so as to be movable in the front and rear direction. A metallic flange (not illustrated) is attached to the base end portions of the ferrules 25 and 26. This flange is urged forward by a coil spring. The front ends of the optical connector portions 23 and 24 respectively open. The proximal end portions of the ferrules 25 and 26 respectively protrude forward from these openings.

The shapes of the first optical connector portion 23 and the second optical connector portion 24 of the embodiment in a cross-section perpendicular to the Z direction are substantially square shapes. The first optical connector portion 23 includes a pair of side surfaces 231 and 232 which faces each other in the X direction and an upper surface 233 and a lower surface 234 which face each other in the Y direction. Similarly, the second optical connector portion 24 includes a pair of side surfaces 241 and 242 which faces each other in the X direction and an upper surface 243 and a lower surface which face each other in the Y direction. One side surface 232 of the first optical connector portion 23 and one side surface 241 of the second optical connector portion 24 face each other. The upper surface 233 of the first optical connector portion 23 and the upper surface 243 of the second optical connector portion 24 respectively face the same direction (the positive Y direction). The lower surface 234 of the first optical connector portion 23 and the lower surface of the second optical connector portion 24 respectively face the same direction (the negative Y direction).

The rear portion 22 of the first housing 20 is provided on the rear side in the Z direction with respect to the first optical connector portion 23 and the second optical connector portion 24. The rear portion 22 of the first housing 20 connects the base end portion of the first optical connector portion 23 and the base end portion of the second optical connector portion 24. The rear portion 22 is hollow. The rear portion 22 collectively accommodates the optical fibers respectively extending from the first optical connector portion 23 and the second optical connector portion 24. The shape of the rear portion 22 of the embodiment in a cross-section perpendicular to the Z direction is a substantially rectangular shape of which the X direction is the longitudinal direction. That is, the rear portion 22 includes a pair of side surfaces 221 and 222 which faces each other in the X direction and an upper surface 223 and a lower surface 224 which face each other in the Y direction. The pair of side surfaces 221 and 222 respectively includes inclined surfaces which are inclined in the X direction. A gap between the pair of side surfaces 221 and 222 is narrowed as it goes toward the rear end. Thus, a gap between the pair of side surfaces 221 and 222 at the rear end side of the rear portion 22 is narrower than a gap between the pair of side surfaces 221 and 222 at the front end side of the rear portion 22.

The boot 50 extends backward from the rear end of the first housing 20 in the Z direction. The boot 50 collectively accommodates the optical fiber extending from the first optical connector portion 23 and the optical fiber extending from the second optical connector portion 24. The boot 50 is a substantially cylindrical member. The boot 50 prevents an excessive bending stress from being generated in the optical fiber extending toward the outside of the first housing 20. The boot 50 is formed of a resin material (for example, thermoplastic elastomers (TPE)) softer than that of the first housing 20. The boot 50 is attached to the first housing 20 so as to be relatively rotatable around a center axis along the Z direction. Further, the outer peripheral surface of the boot 50 has a non-rotationally symmetrical shape around the center axis. In the embodiment, the outer peripheral surface of the boot 50 is provided with a pair of flat surfaces 51 and 52 which faces each other. The pair of flat surfaces 51 and 52 is parallel to each other. The pair of flat surfaces 51 and 52 extends along the Z direction. The flat surfaces 51 and 52 are provided with a mark 53 for easily seeing the rotation position of the boot 50.

As illustrated in FIGS. 1, 2, and 3, the optical fiber cable 3 extends backward from the rear end of the first housing 20 in the Z direction. The end portion of the optical fiber cable 3 is held by the boot 50. The optical fiber cable 3 includes the optical fiber extending from the first optical connector portion 23 and the optical fiber extending from the second optical connector portion 24.

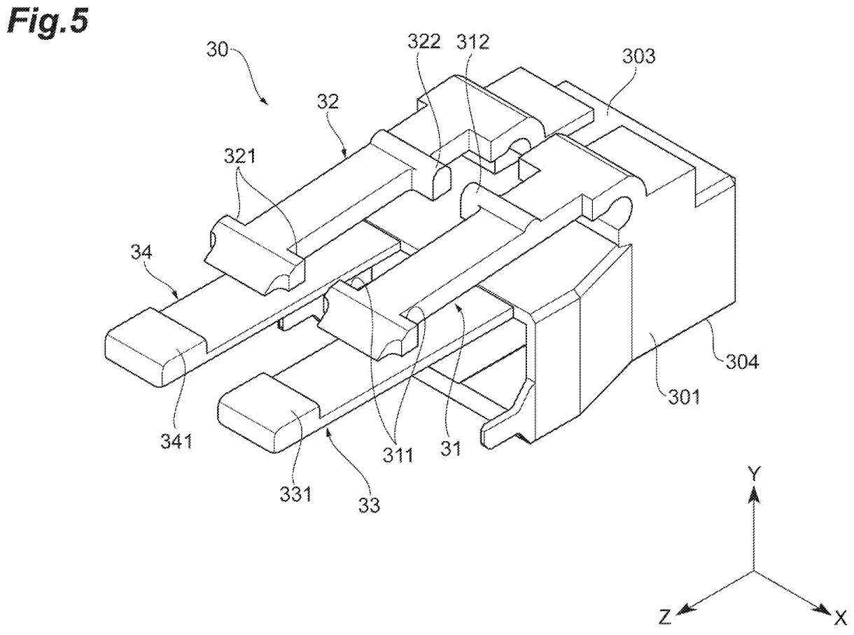

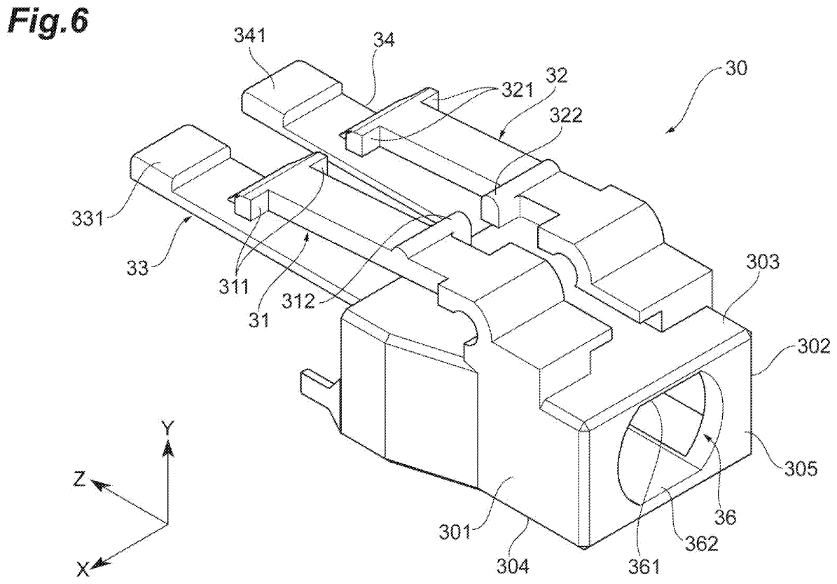

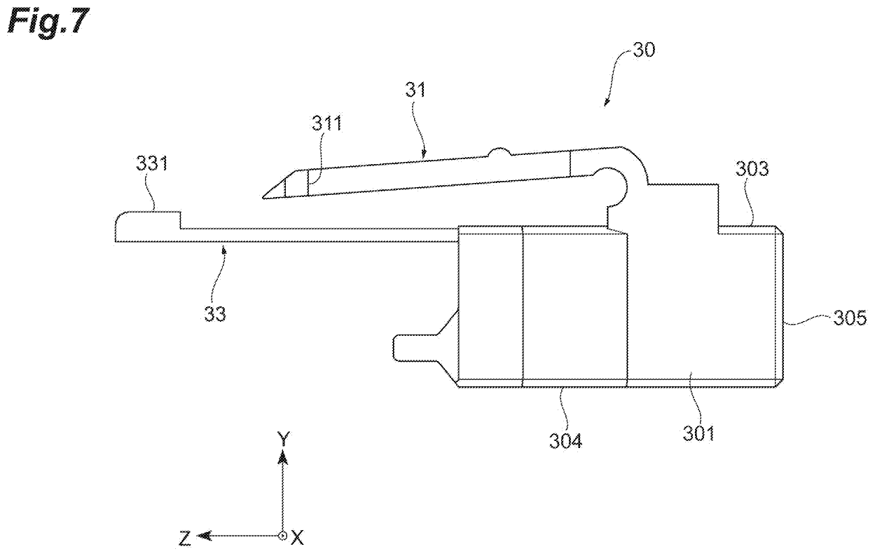

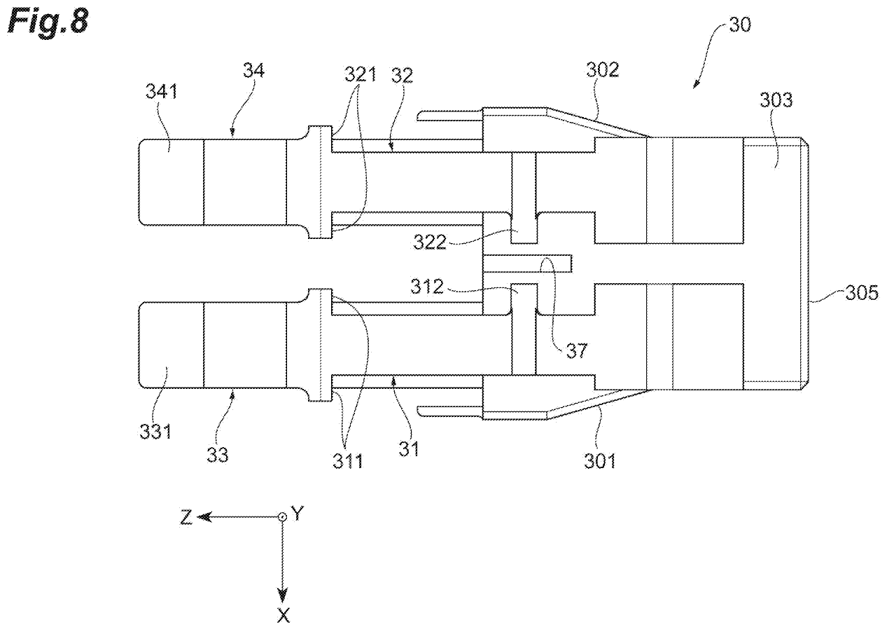

FIG. 5 is a perspective view illustrating the second housing 30 (the outer housing) viewed from the obliquely front side. FIG. 6 is a perspective view illustrating the second housing 30 viewed from the obliquely rear side. FIG. 7 is a side view of the second housing 30. FIG. 8 is a top view of the second housing 30. The second housing 30 is formed of, for example, a resin material called polyetherimide (PEI). The second housing 30 is attached to the rear portion 22 of the first housing 20 in an attachable and detachable manner so as to cover that portion. The shape of the second housing 30 of the embodiment in a cross-section perpendicular to the Z direction is a rectangular shape of which the X direction is the longitudinal direction. The second housing 30 surrounds the rear portion 22 around the center axis of the first housing 20 along the Z direction. Specifically, the second housing 30 includes a pair of side walls 301 and 302, an upper wall 303, a lower wall 304, and a rear end wall 305. The pair of side walls 301 and 302 respectively covers the pair of side surfaces 221 and 222 of the rear portion 22 of the first housing 20. The upper wall 303 covers the upper surface 223 (or the lower surface 224) of the rear portion 22. The lower wall 304 covers the lower surface 224 (or the upper surface 223) of the rear portion 22. The rear end wall 305 covers the rear end of the rear portion 22.

The second housing 30 includes a first latch portion 31 and a second latch portion 32. The latch portions 31 and 32 are arranged in the X direction and extend from the upper wall 303 of the rear portion 22 toward the front portion 21. The front ends of the latch portions 31 and 32 are provided with engagement portions 311 and 321. The engagement portions 311 and 321 respectively engage with the adapter 100 at the inside of the first connector inlet 101 and the inside of the second connector inlet 102 of the adapter 100 illustrated in FIG. 15. The latch portions 31 and 32 engage with the adapter 100 in the engagement portions 311 and 321 when the first optical connector portion 23 and the second optical connector portion 24 are respectively inserted from the first connector inlet 101 and the second connector inlet 102. With this configuration, the latch portions 31 and 32 prevent the unintended removal of the first optical connector portion 23 and the second optical connector portion 24. Additionally, the latch portions 31 and 32 receive a force generated by the tab 40 to be described later. Thus, the latch portions 31 and 32 respectively include bar-shaped portions 312 and 322 extending in the X direction. The bar-shaped portions 312 and 322 are located between the base end portions of the latch portions 31 and 32 (portions fixed to the upper wall 303) and the engagement portions 311 and 321.

The second housing 30 is attachable to the rear portion 22 of the first housing 20 even when the second housing is reversed by 180° around the center axis along the Z direction. In other words, the outer surface of the rear portion 22 of the first housing 20 and the inner surface of the second housing 30 have a rotationally symmetrical shape of 180° around the center axis along the Z direction. Thus, the second housing 30 is attachable to the rear portion 22 in both of a state in which the latch portions 31 and 32 are located on one side of the first housing 20 in the Y direction and a state in which the latch portions 31 and 32 are located on the other side thereof.

The second housing 30 includes an opening 36 provided in the rear end wall 305. The opening 36 has a substantially circular shape through which the boot 50 passes. The opening 36 has a non-rotationally symmetrical shape around the center axis similarly to the outer peripheral surface of the boot 50. In the embodiment, the edge of the opening 36 is provided with a pair of linear portions 361 and 362. A gap between the pair of linear portions 361 and 362 is slightly larger than a gap between the pair of flat surfaces 51 and 52 of the boot 50. Further, the gap between the pair of linear portions 361 and 362 is smaller than the diameter of the outer peripheral surface in the front end of the boot 50 except for the pair of flat surfaces 51 and 52. Thus, when a relative rotation position of the boot 50 with respect to the opening is a rotation position (a first relative rotation position) in which the rotation positions of the pair of flat surfaces 51 and 52 match the rotation positions of the pair of linear portions 361 and 362, the boot 50 can pass through the opening 36. Thus, the second housing 30 can be detached from the first housing 20. Further, when a relative rotation position of the boot 50 is a rotation position (a second relative rotation position, for example, a position further rotated by 90° from the first relative rotation position) different from the first relative rotation position, the boot 50 cannot pass through the opening 36. Thus, the detachment of the second housing 30 from the first housing 20 is prevented.

The second housing 30 further includes a first protrusion portion 33 and a second protrusion portion 34. The first protrusion portion 33 is disposed between the first latch portion 31 and the first optical connector portion 23. The first protrusion portion 33 extends from the upper wall 303 of the rear portion 22 toward the front end of the first optical connector portion 23. The first protrusion portion 33 is inserted into the first connector inlet 101 (see FIG. 15) of the adapter 100 along with the first optical connector portion 23. The front end of the first protrusion portion 33 is provided with a convex portion 331 having a shape matching the cross-sectional shape of the first connector inlet 101. The second protrusion portion 34 is disposed between the second latch portion 32 and the second optical connector portion 24. The second protrusion portion 34 extends from the upper wall 303 of the rear portion 22 toward the front end of the second optical connector portion 24. The second protrusion portion 34 is inserted into the second connector inlet 102 along with the second optical connector portion 24. The front end of the second protrusion portion 34 is provided with a convex portion 341. The convex portion 341 has a shape matching the cross-sectional shape of the second connector inlet 102.

Again, FIGS. 1, 2, and 3 are referred. The tab 40 is a bar-shaped member. The tab 40 is formed of, for example, a resin material having elasticity called polycarbonate (PC). The tab 40 extends from the outer surface of the housing 10 (specifically, the surface of the upper wall 303 of the second housing 30) toward the rear side of the housing 10 along the Z direction. The tab 40 is attached to the upper wall 303 of the second housing 30 so as to be slidable in the Z direction.

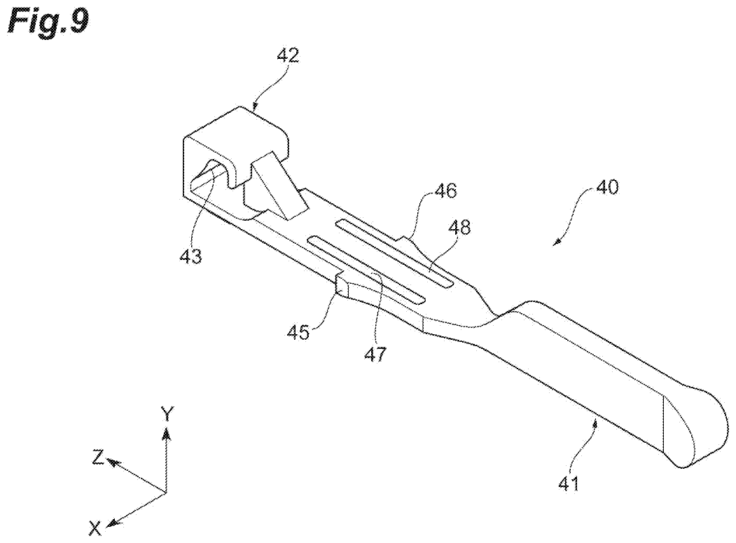

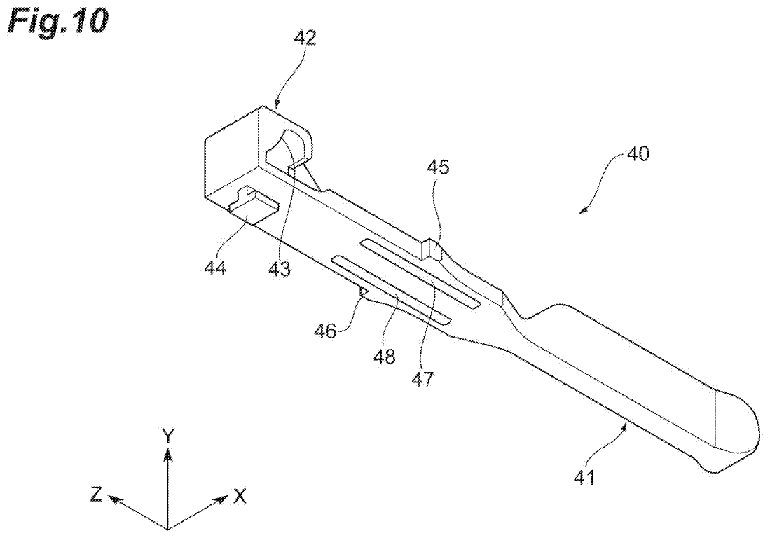

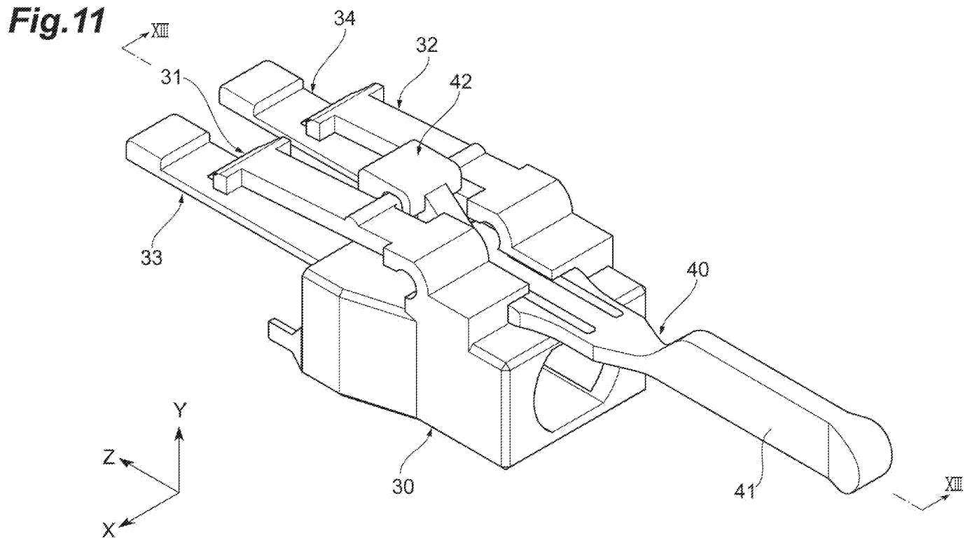

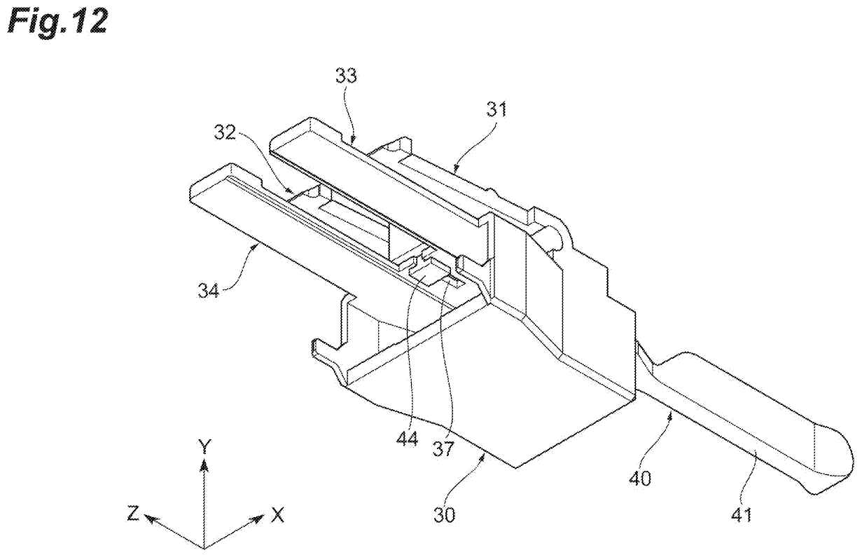

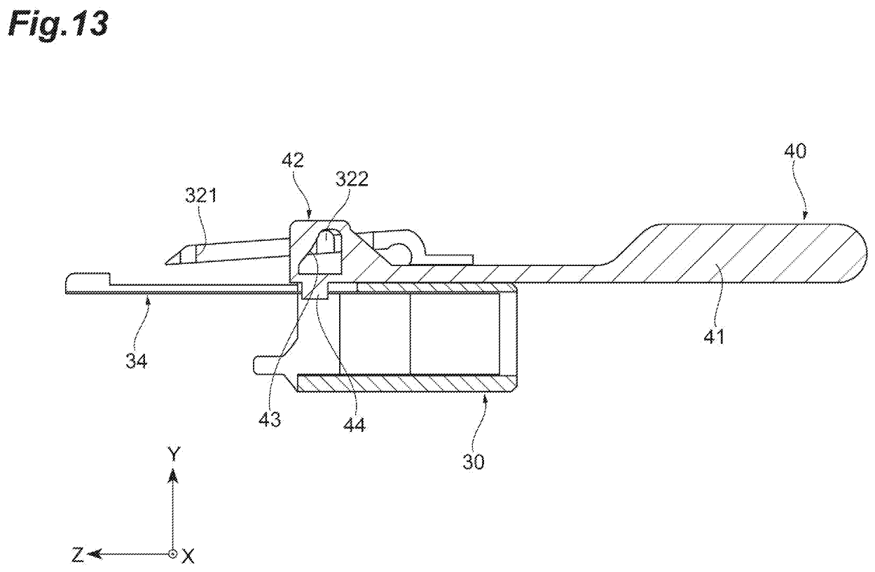

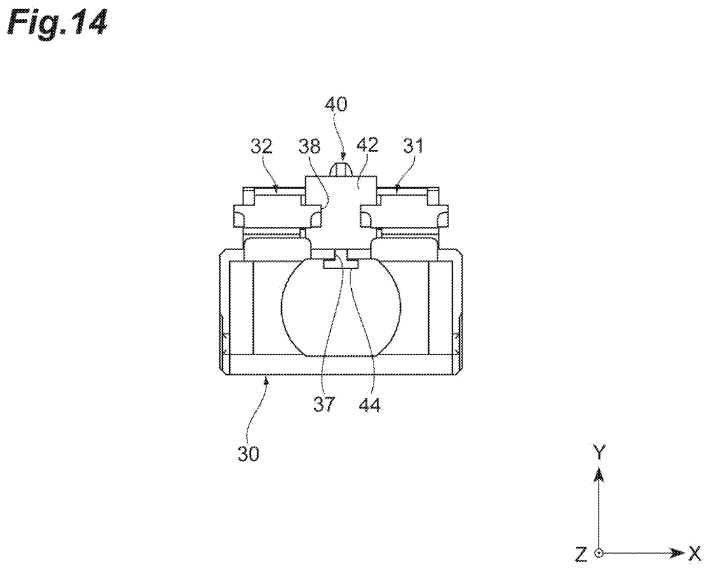

Here, FIG. 9 is a perspective view illustrating the tab 40 viewed from the obliquely upper side. FIG. 10 is a perspective view illustrating the tab 40 viewed from the obliquely lower side. FIG. 11 is a perspective view illustrating an assembly state of the second housing 30 and the tab 40 viewed from the obliquely upper side. FIG. 12 is a perspective view illustrating the assembly state of the second housing 30 and the tab 40 viewed from the obliquely lower side. FIG. 13 is a cross-sectional view taken along a line XIII-XIII illustrated in FIG. 11. FIG. 14 is a front view illustrating the assembly state of the second housing 30 and the tab 40 viewed from the positive Z direction.

As illustrated in FIGS. 9 and 10, the rear end portion of the tab 40 is provided with a grip portion 41 provided for an operator to pinch with fingers. The grip portion 41 is formed in a flat plate shape along the YZ plane for the operator to easily pinch with fingers. Further, the center portion or the front end portion of the tab 40 has a flat plate shape along the XZ plane so as to easily follow the upper surface of the housing 10. An annular portion 42 is provided at the front end portion of the tab 40. One inclined surface 43 is formed on the inner surface of the annular portion 42. This inclined surface 43 is inclined with respect to the Z direction. Specifically, the normal line of the inclined surface 43 is inclined toward the rear side in the Z direction with respect to the Y direction. Additionally, the inclined surface 43 may not be essentially flat. For example, in the embodiment, the inclined surface 43 is a slightly convex curved surface (a cylindrical surface having a curvature in the YZ plane).

As illustrated in FIG. 13, the inclined surface 43 contacts the bar-shaped portions 312 and 322 of the latch portions 31 and 32. Only the bar-shaped portion 322 is illustrated in FIG. 13, but the same applies to the bar-shaped portion 312. When the tab 40 slides backward, this inclined surface 43 also moves backward so that the bar-shaped portions 312 and 322 are pressed by the inclined surface 43. As a result, the latch portions 31 and 32 are pressed so that the engagement between the engagement portions 311 and 321 and the adapter 100 (see FIG. 15) is released. Additionally, the bar-shaped portions 312 and 322 of the embodiment are individually provided in the latch portions 31 and 32.

However, in the bar-shaped portions 312 and 322, the bar-shaped portions of the latch portions 31 and 32 may be connected to each other.

Further, the tab 40 and the housing 10 of the embodiment include a slidable engagement mechanism. As an example, this mechanism includes a slit 37 (see FIGS. 12 and 14) which is fainted in the second housing 30 and a protrusion 44 (see FIGS. 10 and 12 to 14) formed in the tab 40. The slit 37 is an elongated opening formed in the upper wall 303 of the second housing 30. The slit 37 extends in the Z direction. Further, as illustrated in FIG. 10, the protrusion 44 protrudes from the lower surface of the tab 40 toward the lower side in the Y direction (that is, the inside of the second housing 30). The cross-sectional shape of the protrusion 44 along the XY plane is an inverted T shape. Then, a T-shaped leg portion is inserted into the slit 37. With this configuration, the protrusion 44 engages with the slit 37 so as to be movable along the longitudinal direction of the slit 37.

Further, as illustrated in FIG. 6, the second housing 30 includes a narrow portion 38 (see FIG. 14) which sandwiches the tab 40 from a direction (in the embodiment, the X direction) intersecting the Z direction. Meanwhile, as illustrated in FIGS. 9 and 10, the tab 40 includes a pair of protrusions 45 and 46 which protrudes outward in the direction. The front ends of the protrusions 45 and 46 form contact surfaces which extend along the XY plane. The front ends of the protrusions 45 and 46 come into contact with the rear end of the narrow portion 38. The surfaces of the rear portions of the protrusions 45 and 46 constitute a part of the side surface of the tab 40. The surfaces of the rear portions of the protrusions 45 and 46 are inclined with respect to the Z direction so that the width of the tab 40 is gradually narrowed backward.

Further, the tab 40 further includes slits 47 and 48 which are formed between the pair of protrusions 45 and 46. In the embodiment, one slit 47 is provided near one protrusion 45 with respect to the center axis of the tab 40 along the Z direction. The other slit 48 is provided near the other protrusion 46 with respect to the center axis. These slits 47 and 48 pass between the upper surface and the lower surface of the tab 40. The slits 47 and 48 extend in the Z direction. The lengths of the slits 47 and 48 along the Z direction are longer than the lengths of the protrusions 45 and 46 in the same direction.

Next, a configuration of the adapter 100 connected to the optical connector 2 will be described. FIG. 15 is a perspective view illustrating an appearance of the adapter 100. The optical connector 2 is connected to the adapter 100 along the Z direction. The adapter 100 of the embodiment is a so-called dual adapter. The adapter 100 includes a first connector inlet 101 and a second connector inlet 102. As described above, the first optical connector portion 23 of the optical connector 2 is inserted into the first connector inlet 101. Further, the second optical connector portion 24 is inserted into the second connector inlet 102. Further, the latch portion 31 engages with the adapter 100 inside the first connector inlet 101. Further, the latch portion 32 engages with the adapter 100 inside the second connector inlet 102.

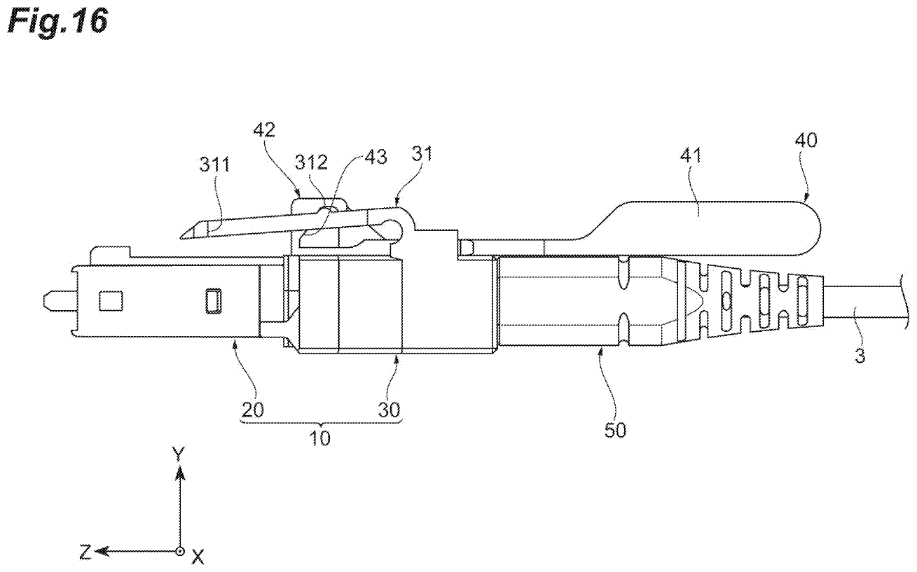

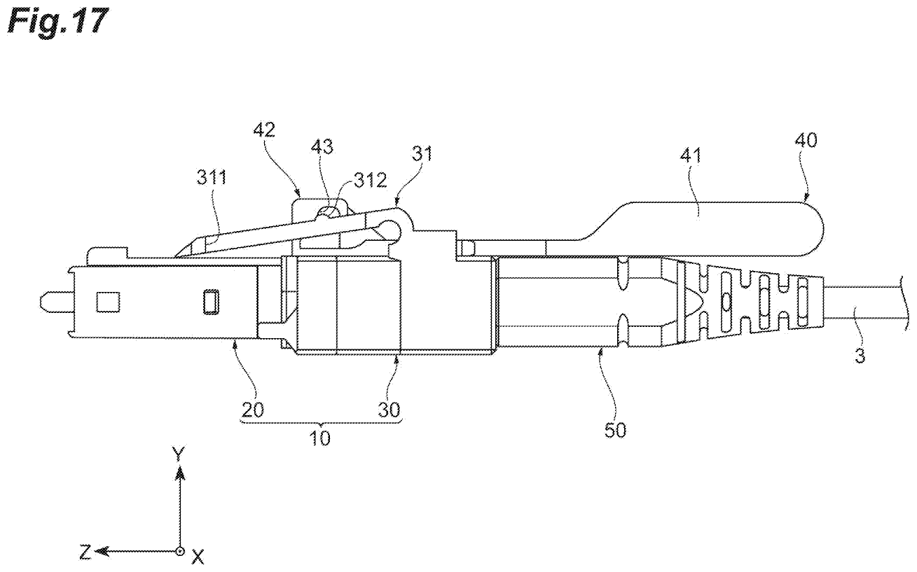

An operation of the optical connector 2 with the above-described configuration at the time of releasing the engagement state of the latch portions 31 and 32 will be described with reference to FIGS. 16 and 17. FIG. 16 illustrates the state of the latch portions 31 and 32 of the second housing 30 when the latch portions engage with the adapter 100 inside the connector inlets 101 and 102. Further, FIG. 17 illustrates the state of the latch portions 31 and 32 when the engagement state with the adapter 100 is released.

As illustrated in FIG. 16, when the latch portions 31 and 32 engage with the adapter 100, the bar-shaped portions 312 and 322 of the latch portions 31 and 32 are located at an upper portion of the annular portion 42 (an upper end of the inclined surface 43). At the time of releasing the engagement state of the latch portions 31 and 32, the operator grips the grip portion 41 of the tab 40 and pulls the tab 40 backward. Accordingly, for example, the protrusion 44 illustrated in FIG. 12 slides backward while engaging with the slit 37. As a result, as illustrated in FIG. 17, the tab 40 moves backward. At the same time, the annular portion 42 and the inclined surface 43 move backward. At this time, the bar-shaped portions 312 and 322 of the latch portions 31 and 32 slide on the inclined surface 43. As a result, the bar-shaped portions 312 and 322 move toward the lower portion of the annular portion 42 (the lower end of the inclined surface 43). In accordance with the movement of the bar-shaped portions 312 and 322, the engagement portions 311 and 321 of the latch portions 31 and 32 move downward. Accordingly, the engagement state between the latch portions 31 and 32 and the adapter 100 is released.

An effect obtained by the optical fiber 1 with the connector and the optical connector 2 of the above-described embodiment will be described. In the optical fiber 1 with the connector and the optical connector 2, the tab 40 which is attached so as to be slidable in the Z direction extends from the upper surface of the housing 10 toward the rear side of the housing 10. Accordingly, the rear end portion (the grip portion 41) of the tab 40 is located at a position in which the tab easily passes through a gap between the optical wirings to reach an easily accessible position. Then, as described above, at the time of releasing the engagement state of the latch portions 31 and 32, the rear end portion (the grip portion 41) of the tab 40 is gripped by a finger and is pulled backward so that the inclined surface 43 of the tab 40 presses the latch portions 31 and 32. Thus, it is possible to easily release the engagement state of the latch portions 31 and 32 even when the density of optical wiring increases. Further, in the optical connector 2, the tab 40 and the housing 10 have a slidable engagement mechanism. Accordingly, for example, a large-scale configuration as in the slider described in Patent Literatures 1 and 2 is not required. Thus, it is possible to simplify a structure for releasing the engagement state of the latch portions 31 and 32.

Further, as in the embodiment, the mechanism may include the slit 37 which is formed in the housing 10 and extends in the Z direction and the protrusion 44 which is formed in the tab 40, engages with the slit 37, and has a T-shaped cross-section. For example, according to such a configuration, a slidable engagement mechanism of the tab 40 and the housing 10 can be realized by a simple configuration.

Further, as in the embodiment, the housing 10 may include the narrow portion 38 which sandwiches the tab 40 from a direction intersecting the Z direction, the tab 40 may include the pair of protrusions 45 and 46 which protrudes outward in the direction, the front ends of the protrusions 45 and 46 may come into contact with the rear end of the narrow portion 38, and the surfaces of the rear portions of the protrusions 45 and 46 may be inclined with respect to the Z direction. According to such a configuration, the inclined surfaces of the protrusions 45 and 46 are gradually press-inserted into the narrow portion 38 at the time of inserting the tab 40 from the front side of the narrow portion 38. Thus, the tab 40 can be easily attached to the housing 10. Further, the protrusions 45 and 46 protrude again after the protrusions 45 and 46 pass through the narrow portion 38. The front ends of the protrusions 45 and 46 come into contact with the rear end of the narrow portion 38. Thus, the tab 40 can be reliably attached to the housing 10. Further, at the time of connecting the optical connector 2 to the adapter 100, a force in which the operator presses the tab 40 forward can be transmitted to the housing 10 through the protrusions 45 and 46 and the narrow portion 38.

Further, when the tab 40 includes the protrusions 45 and 46 in this way, the tab 40 may further include the slits 47 and 48 formed between the pair of protrusions 45 and 46. Accordingly, the pair of protrusions 45 and 46 can be elastically bent toward the inside of the tab 40. Thus, the tab 40 can be more easily attached to the housing 10.

The optical connector and the optical fiber with the connector according to the disclosure are not limited to the above-described embodiment and can be modified into various other forms. For example, in the above-described embodiment, the housing 10 includes the first housing 20 and the second housing 30. However, the housings may be integrally formed with each other. Further, in the above-described embodiment, the housing 10 includes two optical connector portions (the first optical connector portion 23 and the second optical connector portion 24). However, the optical connector portion of the housing may be single. Further, as the mechanism for preventing the separation of the second housing 30, the opening 36 of the second housing 30 is provided with the pair of linear portions 361 and 362 and the boot 50 is provided with the pair of flat surfaces 51 and 52. However, the mechanism for preventing the separation of the second housing is not limited thereto. As the mechanism for preventing the separation of the second housing, various mechanisms capable of controlling the backward movement of the second housing by the rotation of the boot can be employed. Further, in the above-described embodiment, as the mechanism for engaging the second housing 30 with the tab 40, the slit 37 and the T-shaped protrusion 44 are exemplified. However, the mechanism is not limited to such a configuration. As the mechanism, various configurations in which the tab slidably engages with the second housing can be employed. Further, in the embodiment, the second housing 30 surrounds the rear portion 22 around the center axis of the first housing 20. However, the second housing may have any shape as long as the second housing is attachable to and detachable from the rear portion of the first housing. Further, in the above-described embodiment, the tab 40 includes two slits 47 and 48 between the protrusions 45 and 46. However, one slit may be provided. Further, three or more slits may be provided. Further, in the above-described embodiment, a case in which the optical connector is connected to the adapter has been described. However, the optical connector of the disclosure may be connected to the receptacle having the same connection mechanism as that of the adapter.

### REFERENCE SIGNS LIST

1: optical fiber with connector, 2: optical connector, 3: optical fiber cable, 10: housing, 20: first housing, 21: front portion, 22: rear portion, 23: first optical connector portion, 24: second optical connector portion, 25, 26: ferrule, 30: second housing, 31: first latch portion, 32: second latch portion, 33: first protrusion portion, 34: second protrusion portion, 36: opening, 37: slit, 38: narrow portion, 40: tab, 41: grip portion, 42: annular portion, 43: inclined surface, 44: protrusion, 45, 46: protrusion, 47, 48: slit, 50: boot, 51, 52: flat surface, 100: adapter, 101: first connector inlet, 102: second connector inlet.

1. An optical connector which is connected to an adapter or a receptacle in a first direction, comprising:
a housing which includes an optical connector portion provided in a front portion in the first direction and inserted into a connector inlet of the adapter or the receptacle and a latch portion extending from a rear portion to the front portion in the first direction and engaging with the adapter or the receptacle; and
a tab which extends from an outer surface of the housing to a rear side of the housing in the first direction and is attached to the outer surface so as to be slidable in the first direction,
wherein the latch portion includes a portion which extends in a second direction intersecting the first direction,
wherein the tab includes an inclined surface which is inclined with respect to the first direction and contacts the portion and slides backward to press the portion, and
wherein the tab and the housing have a slidable engagement mechanism.

2. The optical connector according to claim 1,
wherein the mechanism includes a slit which is formed in the housing and extends in the first direction and a protrusion which is formed in the tab, engages with the slit, and has a T-shaped cross-section.

3. The optical connector according to claim 1,
wherein the housing includes a narrow portion which sandwiches the tab from a direction intersecting the first direction,
wherein the tab includes a pair of protrusions which protrudes outward in the direction,
wherein a front end of the protrusion comes into contact with a rear end of the narrow portion, and
wherein a surface of a rear portion of the protrusion is inclined with respect to the first direction.

4. The optical connector according to claim 3,
wherein the tab further includes a slit which is formed between the pair of protrusions and extends in the first direction.

5. An optical fiber with a connector comprising:
the optical connector according to claim 1; and
an optical fiber cable which includes an optical fiber extending from the optical connector portion and extends backward from a rear end of the housing in the first direction.
